(19) United States
(12) Patent Application Publication
(10) Pub. No.: US 2012/0265412 A1
(43) Pub. Date: Oct. 18, 2012

(54) Agricultural hauling vehicle and vehicle network

(76) Inventors: Norbert Diekhans, Guetersloh (DE); Jochen Huster, Guetersloh (DE); Frank Claussen, Harsewinkel (DE); Max Reinecke, Versmold (DE)

(21) Appl. No.: 13/429,867

(22) Filed: Mar. 26, 2012

(30) Foreign Application Priority Data
Apr. 12, 2011 (DE) 10 2011 016743.9

(51) Int. Cl. A01D 41/127

(52) U.S. Cl. 701/50

(57) ABSTRACT

An agricultural hauling vehicle for receiving material from a traveling original vehicle during travel adjacent to the original vehicle is provided with a hauling container that is fillable from above for receiving the material. A sensor detects the distribution of the material in the hauling container and a control unit varies the position of the hauling vehicle relative to the traveling original vehicle on the basis of the distribution of material detected by the sensor. Preferably the sensor is a camera.

### CROSS-REFERENCE TO A RELATED APPLICATION

The invention described and claimed hereinbelow is also described in German Patent Application DE 10 2011 016743.9, filed on Apr. 12, 2011. The German Patent

Application, whose subject matter is incorporated by reference herein, provides the basis for a claim of priority of invention under 35 U.S.C. 119(a)-(d).

### BACKGROUND OF THE INVENTION

The present invention relates to an agricultural hauling vehicle for receiving material from an original vehicle such as a self-propelled harvesting machine (e.g., a forage harvester or a combine harvester), and a network of a plurality of vehicles which are coordinated with one another.

Such a hauling vehicle and a vehicle network are known from WO 00/35265 A1. The original vehicle(s) of this conventional network are one or more combine harvesters which harvest a field and transfer the crop to a hauling vehicle. The hauling vehicle is a tractor comprising a trailer. When the trailer is full, the tractor searches for a truck parked at the edge of the field in order to transfer the crop thereto.

For transferring, each of the combine harvesters comprises an upper discharge chute which transfers the crop in a tightly bundled stream to the trailer. When the tractor and trailer travel next to one another at exactly the same ground speed, the position of the upper discharge chute relative to the trailer does not vary, and the crop forms a heaped cone on the trailer. When it reaches the loading edge of the trailer, transfer to the trailer must be interrupted since crop would become lost otherwise, and the tractor must search for the hauling vehicle on the edge of the field to unload the crop there before transfer from the combine harvester can be continued. The tractor therefore travels unnecessarily long distances on the field, which results in unwanted compression of the ground and greatly impairs the economy of the harvesting process since the hauling vehicle consumes fuel unnecessarily and the number of combine harvesters that it can serve simultaneously is reduced.

### SUMMARY OF THE INVENTION

The present invention provides improvements to known prior art systems, at least some of which overcome the above-mentioned shortcomings.

In an embodiment, the invention provides a hauling vehicle for the transfer of material, in particular crop, from a traveling original vehicle comprising a hauling container which can be filled from above for receiving material. At least one sensor detects the distribution of the material in the hauling container. A control unit varies the position of the hauling vehicle relative to the traveling original vehicle on the basis of the distribution of material that was detected. As the sensor delivers information to the control unit regarding regions of the hauling container that are loaded to different extents, the control unit can adjust the position of the hauling vehicle relative to the original vehicle at any time in such a way that material from the original vehicle is loaded into a relatively sparsely loaded region of the hauling container. If the fill level of the material in the hauling container is evened out in this manner, the capacity of the hauling container can be fully utilized and the number of trips taken by the hauling vehicle can be minimized.

The control unit is arranged to estimate the ground speed of the original vehicle. In order to vary the position relative to the original vehicle, the control unit adjusts the ground speed of the hauling vehicle in such a way that it deviates temporarily from the estimated ground speed.

A camera is preferably used as a sensor for detecting the material distribution. An advantage of the camera over other sensor types is that it enables the fill level of the material to be detected at various points in the hauling container, and enables a transfer stream from the original vehicle, such as the stream from an upper discharge chute, to be localized, thereby simultaneously enabling the position of the hauling vehicle relative to the original vehicle to be deduced.

In particular, when the hauling vehicle is a combination of a pulling vehicle and a trailer which can be coupled to the pulling vehicle, the camera is fixedly assigned to the hauling container to ensure that it is placed correctly and is optically capable of viewing across the surface of the material in the hauling container and thereby delivering the data required to determine the fill level.

A camera also can be provided for detecting the ground over which the hauling vehicle travels and/or for detecting the original vehicle. It makes sense to detect the original vehicle in particular while the hauling vehicle approaches the original vehicle to prepare for transfer, e.g., so that the control unit can automatically control the approach to the original vehicle without the need for driver intervention on the basis of this information. Alternatively, the control unit can only warn a driver of the hauling vehicle that the original vehicle is dangerously close.

The same camera can be used to detect the fill level of the hauling container and to detect the ground and/or the original vehicle. Since the same camera is used for different tasks at different times, the costs of the hauling vehicle can be minimized.

Furthermore, the hauling vehicle should comprise an outlet connected to the hauling container for transferring material from the hauling container into an external container such as the loading space of a further vehicle, for example.

A camera also may be provided in the external container to monitor it during transfer. It is preferably the same camera that can also be used to detect the original vehicle or the fill level in the hauling container.

The control unit of the hauling vehicle can be furthermore set up to monitor the fill level of the external container and to vary the placement of the outlet relative to the external container depending on the fill level thereof and on the transfer progress. The costs of an associated control system on the external container can thereby be saved, while still ensuring that the external container is also loaded evenly and completely.

A route planning system for automatically planning routes of the hauling vehicle between at least one original vehicle to be unloaded and an unloading support point such as the external container is preferably a component of the control unit of the hauling vehicle according to the invention.

The route planning system is arranged to receive data related at least to the loading state and the position of the original vehicle from the original vehicle in real time and, on the basis of these data, to define a meeting point for the agricultural hauling vehicle and the original vehicle. It can thereby be ensured that the hauling vehicle does not travel unnecessarily long distances, but the original vehicle will still be unloaded in a timely manner in order to permit economical operation with few interruptions.

To simplify the coordination of the hauling vehicle with the original vehicle, the route planning system of the hauling vehicle can be set up to define a route for the original vehicle as well, and to transmit it thereto. The control unit also may be arranged to navigate the hauling vehicle autonomously along a route that was planned by the route planning system.

In another embodiment, the invention provides an agricultural vehicle network comprising a hauling vehicle as described above, and at least one original vehicle. The original vehicle is preferably a combine harvester or another harvesting vehicle which comprises a tank for collecting crop. Since such an original vehicle does not need to be accompanied by a hauling vehicle constantly in order to receive the crop, a single hauling vehicle can serve a plurality of original vehicles simultaneously.

### BRIEF DESCRIPTION OF THE DRAWING FIGURES

Further features and advantages of the invention will become apparent from the description of embodiments that follows, with reference to the attached figures. Shown are:

FIG. 1 depicts a vehicle network according to the invention, during use; and

FIGS. 2-4 together depict stages of transfer from the combine harvester to the hauling vehicle.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

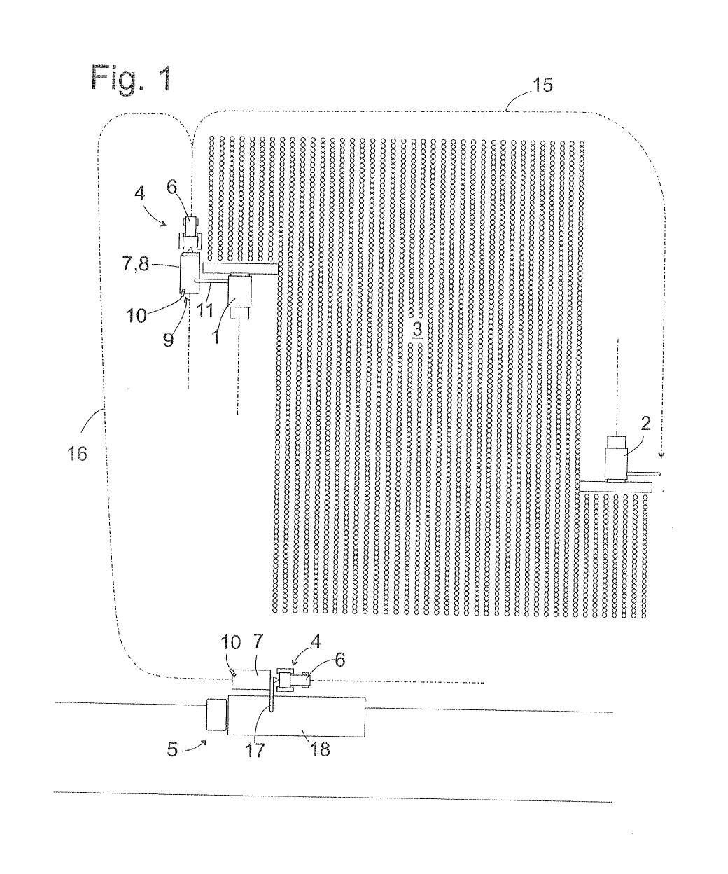

FIG. 1 shows a typical situation for use of a vehicle network according to the invention. In this case, the network comprises two combine harvesters 1, 2, which simultaneously harvest a crop area 3 on a field, a road hauling vehicle 5 and a field hauling vehicle 4. When used as shown in FIG. 1, the field hauling vehicle 4 circulates between the combine harvesters 1, 2 and the road hauling vehicle 5, to pick up grain from the combine harvesters 1, 2 when the grain tanks thereof reach a critical fill level, and deliver it to the road hauling vehicle 5. According to a different use, the road hauling vehicle 5 could also be omitted and, instead, the field hauling vehicle 4 could deliver the grain directly to a stationary storage unit, even via a road.

A fieldwork computer of the field hauling vehicle 4, which is referred to in the following simply as a hauling vehicle 4, is connected to a wireless transmitter/receiver in a manner known per se in order to receive satellite signals, in particular GPS signals, and, on the basis of these signals, to determine the exact position of the hauling vehicle 4. The transmitter/receiver further serves for wireless communication with the combine harvesters 1, 2 which are equipped with related transmitters/receivers and are capable of determining their own position and reporting to the fieldwork computers of the hauling vehicle 4.

On the basis of map data on the field to be processed, the fieldwork computer of the hauling vehicle 4 plans routes that the combine harvesters 1, 2 must travel to harvest the field, and transmits them wirelessly to the combine harvesters 1, 2. The combine harvesters 1, 2 can travel these planned routes autonomously and fully automatically, or the routes defined for any one of the combine harvesters 1, 2 can be displayed to a driver of the particular combine harvester, and it is up to him to travel this route exactly, possibly with consideration for events that cannot be foreseen in the route planning.

On the basis of feedback from the combine harvesters 1, 2 on the fill level of the grain tanks thereof, the fieldwork computer is capable of estimating when each of the combine harvesters 1, 2 must be unloaded to prevent work from being interrupted due to the grain tanks overfilling, and at which location on the defined route they are likely to be found at that point in time. In a timely manner in advance, the fieldwork computer starts the hauling vehicle 4 moving in the direction of the estimated meeting point, or it outputs a request to a driver of the hauling vehicle 4 to do this.

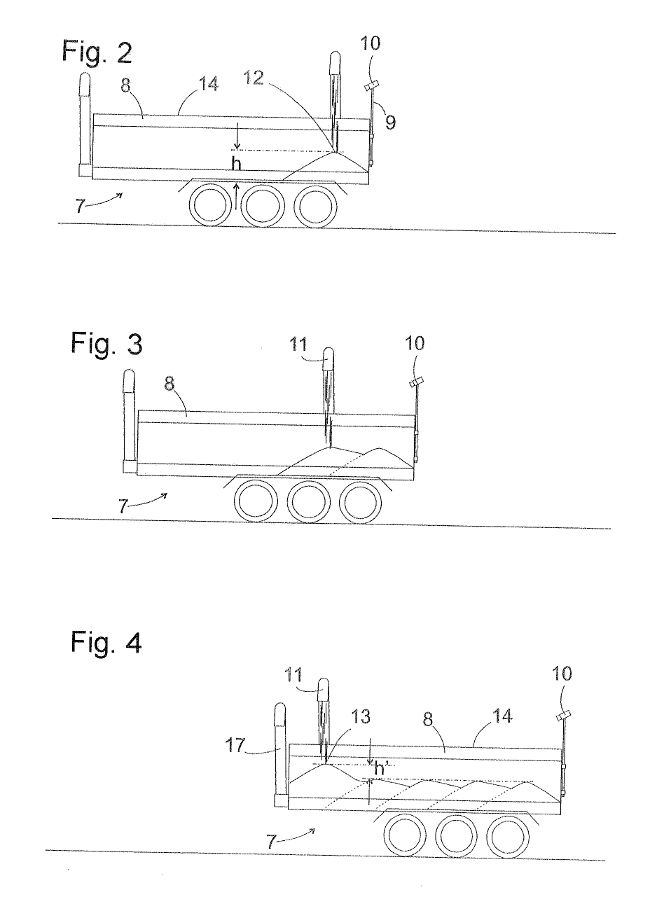

In the case under consideration here, the hauling vehicle 4 is a tractor 6 having a trailer 7, which is depicted schematically in FIG. 2. Trailer 7 carries a hauling container 8, which is approximately cuboid and is open toward the top. A vertical mast 9 is mounted on a rear wall of the hauling container 8, which carries a camera 10 on the tip thereof, which is coupled to the fieldwork computer. The camera 10 can be swiveled in two degrees of freedom on the mast 9, being controlled by the fieldwork computer, to aim at objects in different directions and ^{at} different distances.

During the approach to the planned meeting point, e.g. with the combine harvester 1, the fieldwork computer first directs the camera 10 to the combine harvester 1 in order to estimate the position of the hauling vehicle 4 relative to the combine harvester 1, and to bring the hauling container 8 in position under an outlet end of an upper discharge chute 11 of the combine harvester 1.

During the approach to the combine harvester 1, the fieldwork computer estimates the ground speed of the combine harvester 1 on the basis of the development, over time, of the position of the hauling vehicle 4 relative to the combine harvester 1 and the ground speed of the hauling vehicle 4, and, as soon as a target position of the trailer 7 under the upper discharge chute 11 which is suitable for transfer has been reached, the fieldwork computer compares the ground speed of the hauling vehicle 4 to that of the combine harvester 1.

The camera 10 is now oriented toward the loading surface of the trailer 7, whereby the free end of the upper discharge chute 11 also comes to rest in the field of view thereof. The fieldwork computer can therefore detect and, possibly, correct changes in the relative position of the hauling vehicle 4 and the combine harvester 1 at any time during the subsequent transfer on the basis of the position and size of the upper discharge chute 11 in the images delivered by the camera 10.

On the basis of the images delivered by the camera 10, the fieldwork computer furthermore estimates the distribution of the grain in the trailer 7. If the computer detects (on a basis of the camera images), for example, that the peak of a heaped cone 12 underneath the outlet of the upper discharge chute 11 is higher by a critical dimension than the fill level of the grain in other regions of the hauling container 8, the computer sets the ground speed of the hauling vehicle 4 to a value that deviates slightly from the ground speed of the combine harvester 1 for a certain period of time in order to displace the outlet of the upper discharge chute in the longitudinal direction of the trailer 7. If, as shown in FIG. 2, for example, loading of the trailer 7 starts at the rear thereof, the fieldwork computer gradually slows the hauling vehicle 4 when a critical height h of the heaped cone 12 is reached, which therefore drops back relative to the combine harvester 1, and a region of the hauling container 8 located further forward is loaded, as shown in FIG. 3.

The critical height h can correspond to the height of a loading edge 14 of the hauling container 8. That is, the hauling container 8 is displaced relative to the combine harvester 1 when the heaped cone has reached the loading edge 14 and additional grain that is added would fall out of the hauling container 8 over the loading edge 14. This process of displacing the hauling container 8 relative to the combine harvester 1 can be repeated as necessary depending on the length of the hauling container 8 until the upper discharge chute 11 has reached a front end of the hauling container 8 and the trailer 7 has been loaded evenly along the entire length thereof.

If the critical height h is below the loading edge 14, the upper discharge chute 11 discharges at the front end of the hauling container 8, as shown in FIG. 4, until the height of a heaped cone 13 produced there exceeds the fill level in the rear region of the hauling container 8 by a critical dimension h′. This critical dimension h′ can be smaller than the height difference h which, in the case depicted in FIG. 2, triggered a change in the position of the hauling vehicle 4 relative to the combine harvester 1. Expediently, the critical dimension h′ is defined to be that much smaller, the closer the middle fill level of the hauling container comes to the loading edge 14 thereof. The hauling vehicle 4 now moves temporarily faster than the combine harvester 1 in order to fill the hauling container 8 from front to back in steps along the entire length thereof to the level of the heaped cone 13. The upper discharge chute 11 may travel back and forth repeatedly in this manner over the trailer 7 in the longitudinal direction thereof until the grain tank of the combine harvester 1 is empty.

If the capacity of the trailer 7 is sufficient to accommodate the contents of a further grain tank, the fieldwork computer plans a route 15 (see FIG. 1) for the hauling vehicle 4, on which it can still search for the combine harvester 2 in order to unload it. Otherwise, the hauling vehicle controls the road hauling vehicle on a route 16 in order to transfer the collected grain thereto.

Once the hauling vehicle 4 has reached the road hauling vehicle 5, the camera 10 points thereto in order to detect the position and extension of a loading space 18 of the road hauling vehicle 5 and, during transfer to the road hauling vehicle 5, the fieldwork computer, utilizing knowledge of the length of the loading space 18 and the quantity of grain collected on the trailer 7, controls travels of the hauling vehicle 4 past the loading space in a stepped or continuous manner in such a way that the trailer 7 is empty when an upper discharge chute 17 of the hauling vehicle 4 has reached the end of the loading space 18. It is thereby possible to ensure even distribution of the grain in the loading space 18 and, therefore, good utilization of the loading capacity of the road hauling vehicle 5 without it needing to have its own means for detecting the load distribution and controlling the transfer process.

An alternative strategy for transfer into the loading space 18 is based on the monitoring thereof by the camera 10. Although it is generally incapable of seeing the bottom of the loading space 18, it can see the grain therein when the fill level in the loading space 18 reaches the upper edge thereof. At the beginning of the transfer, the control unit therefore places the upper discharge chute 17 at one end of the loading space 18 or, if the fill level at this end has already reached a maximum permissible level, it searches, starting at this end, for a region of the loading space 18 that is still capable of receiving. If such a region is found, it is filled until the maximum permissible level is reached, and the hauling vehicle 4 is then moved further until another region capable of receiving is found. The entire loading space 18 can also be filled evenly in the course of one or more transfer processes.

The following list of identifiers of various elements and references is included (as follows), for ease of explanation:
1 Combine harvester
2 Combine harvester
3 Crop area
4 Field hauling vehicle
5 Road hauling vehicle
6 Tractor
7 Trailer
8 Hauling container
9 Mast
10 Camera
11 Upper discharge chute
12 Heaped cone
13 Heaped cone
14 Loading edge
15 Route
16 Route
17 Upper discharge chute
18 Loading space

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural hauling vehicle (4) for receiving material from a traveling original vehicle (1, 2) during travel adjacent to the original vehicle (1, 2), comprising:
a hauling container (8), which can be filled from above, for receiving material,
at least one sensor (10) for detecting the distribution of the material in the hauling container (8), and
a control unit for varying the position of the hauling vehicle (4) relative to the traveling original vehicle (1, 2) on the basis of the distribution of material that was detected.

2. The agricultural hauling vehicle according to claim 1, wherein the control unit estimates a ground speed of the original vehicle (1) and sets a ground speed of the hauling vehicle (4) in deviation from the estimated ground speed in order to vary the position of the hauling vehicle.

3. The agricultural hauling vehicle according to claim 1, wherein the at least one sensor is a camera (10).

4. The agricultural hauling vehicle according to claim 3, wherein the at least one camera (10) is provided for detecting the original vehicle (1, 2).

5. The agricultural hauling vehicle according to claim 4, wherein the camera (10) is assigned to the hauling container (8).

6. The agricultural hauling vehicle according to claim 4, wherein the camera (10) can be used to detect a fill level and detect the original vehicle (1, 2).

7. The agricultural hauling vehicle according claim 1, further comprising an outlet (17) connected to the hauling container (8) for transferring material into an external container (16).

8. The agricultural hauling vehicle according to claim 6, wherein the camera (10) detects an external container (16) during transfer.

9. The agricultural hauling vehicle according to claim 7, wherein the control unit varies a placement of the outlet (17) relative to the external container (16) in accordance with a fill level of the hauling container (8).

10. The agricultural hauling vehicle according to claim 7, wherein the control unit varies a fill level of the external container (16) and varies a placement of the outlet (17) relative to the external container (16) depending on the fill level thereof.

11. The agricultural hauling vehicle according to claim 1, wherein the control unit comprises a route planning system for automatically planning routes of the hauling vehicle (4) between at least one original vehicle (1, 2) to be unloaded and an unloading support point (5).

12. The agricultural hauling vehicle according to claim 9, wherein the route planning system receives data related at least to a loading state and a position of the original vehicle (1, 2) from the original vehicle (1, 2) in real time and, on the basis of these data, defines a meeting point for the agricultural hauling vehicle (4) and the original vehicle (1, 2).

13. The agricultural hauling vehicle according to claim 9, wherein the route planning system defines a route of the original vehicle (1, 2) and transmits the route to the original vehicle (1, 2).

14. The agricultural hauling vehicle according to claim 1, wherein the control unit navigates the hauling vehicle (4) autonomously along a route planned by the route planning system.

15. An agricultural vehicle network comprising a hauling vehicle (4) according to claim 1, wherein the original vehicle (1, 2) is a combine harvester.
